(19) United States
(12) Patent Application Publication
(10) Pub. No.: US 2004/0165332 A1
(43) Pub. Date: Aug. 26, 2004

(54) Magnetic holding device

(76) Inventor: Robert Beson, Arcadia (AU)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/680,552

(22) Filed: Oct. 6, 2003

Related U.S. Application Data
(63) Continuation of application No. PCT/AU02/00431, filed on Apr. 4, 2002.

(30) Foreign Application Priority Data
Apr. 5, 2001 (AU) PR 4247

(51) Int. Cl. H01H 47/00

(52) U.S. Cl. 361/144

(57) ABSTRACT

A magnetic holding (1) device and method of manufacturing same are disclosed. The device has a support structure (10) made of an iron alloy and has a substantially planar bearing surface with at least one magnetic (20) or magnetisable region located therein. Insulating means (30) made of non magnetic material are interposed between said magnetic regions and said support structure to resist magnetic induction of, or leakage to, said support structure.

### TECHNICAL FIELD

This invention relates to a magnetic holding device and a process for using same. More particularly, in one aspect, this invention relates to a magnetic holding device for use with a ferrous metal-backed or ferrous metal-incorporated impression die in a stamping, blocking, embossing or debossing process or any combination thereof.

This invention also relates to a metal conductor, and more particularly to a metal conductor for use as a magnetic holding device, the conductor comprising regions of poor conductivity and thermally or electrically conductive regions. Furthermore, this invention also relates to a method for aligning a die on a magnetic holding plate for use in a graphic art design process.

### BACKGROUND ART

Stamping, blocking, embossing or debossing processes (generically referred to hereafter as “graphic art design processes”), typically involve the use of stamping or blocking dies prepared by etching or engraving a desired design in the outer surface of a metal plate, normally magnesium, zinc, copper, brass or steel. It has been a standard in the field to make the dies of a sufficient thickness (about 6.35 to 7 mm depending on the jurisdiction) to withstand the rigours of the graphic art design process over time. In North, Central and South America and in the United Kingdom the standard is ¼ inch. Elsewhere the standard is 7 mm.

Motivated by cost imperatives, brass, copper, magnesium, zinc or polymeric (or composites thereof) steel-backed dies of minimal thickness (say 1 mm to 1.75 mm) were developed for use in graphic art design processes. In particular, steel-backed photopolymer dies have been developed in which a hardened photopolymeric composition bearing the required design cladded onto a thin steel (0.3 mm) backing plate has been developed. The minimal amount and the low cost of the materials included in such steel-backed dies has led to their increasing use as the preferred die in such stamping processes.

However, due to their relative lack of depth, it is necessary to include a solid spacer plate between the die and a chase of the stamping or embossing machine to enable the continued use of existing equipment without the need for height adjustment. Such spacer plates have generally been required to be secured to the chase using mechanical attachment means such as a screw down locking arrangement.

During the graphic art design process the die is subjected to significant forces which will laterally shift the die relative to the spacer plate unless the die and spacer plate are clamped together. To avoid the necessity for clamping means such as the mechanical attachment means referred to above, spacer plates have been described having embedded permanent magnets to hold the steel backed die in position during the graphic art design process. Such a spacer plate is described in U.S. Pat. No. 5,904,096 (Fawcett et al). However, the spacer plate in Fawcett et al is made of non-ferrous material which has a short effective lifetime due to the softness of the metal. Further, the difference in thermal conductivity compared to the steel back die renders such non-ferrous metal spacer plates largely unuseable.

An arrangement described in U.S. Pat. No. 6,152,035 (Scholtz et al) claims to more firmly affix the die to the spacer plate described in Fawcett. In the Scholtz et al arrangement the permanent magnets are described as being made of a material having a superior temperature of remanence. This enables the spacer plate to exhibit strong magnetic attractive force at the high temperatures required in, for example, hot foil stamping processes. It will be understood by those skilled in the art that magnetic properties diminish with increase in temperature.

However, the use of square magnets arranged in a “doggy bone” arrangement in Scholtz et al is considered counter-productive in that the magnetic flux generated by the magnetic material per unit volume is less than optimal. It is considered that optimal magnetic flux is obtained using spaced circular magnets, such as disc or cylindrical shaped magnets. The spacer plate in Scholtz et al projects a magnetic field in one direction only corresponding to the upper face thereof. Accordingly, other attachment means such as mechanical attachment means are required to fix the spacer plate itself to the chase.

Also the production of the Scholtz et al plate is labour intensive due to the amount and difficulty of the machining involved. Moreover, the disadvantages inherent in the use of non-ferrous materials to form the spacer plate render the arrangement described in Scholtz et al less than satisfactory. It is anticipated that the manufacturing costs of the Scholtz et al plate will exceed those made in accordance with the present invention by a factor of 10.

It has been found that spacer plates made from non-ferrous metals or their alloys such as copper, brass or aluminium display insufficient resiliency during long production runs, leading to early cratering of the plate and consequent physical failure of the magnets embedded therein. The repeated impact of the die on the spacer plate leads to concave depressions in the upper surface of the spacer plate. Such craters become problematic and begin to affect the efficacy of the stamping process when they become as deep as 40 thousands of an inch. Accordingly, cratering is a serious problem in the industry and requires either the regular replacement of spacer plates or at least regular surface grinding to maintain efficacy during the graphic art design process. Aside from the expense of either requirement, the regular grinding means the need for height adjustment to maintain constant pressure each time spacer plates are ground.

Relative to steel, these non-ferrous materials such as bronze, brass, copper alloys, aluminium alloys, magnesium alloys, nickel and zinc, are more malleable. This is of importance in processes involving high impact forces in terms of pounds per square inch (psi).

These nonferrous metals are also currently considerably more expensive than steel products. However, the use of ferrous metals such as steel in the spacer plate has heretofore not been considered an option for magnetic spacer plates due to its magnetic properties and the resultant dissipation of magnetic flux if it is permitted to be generally distributed across the spacer plate.

Iron and its alloys are known for their poor thermal and electrical conductivity whilst having other attractive properties such as strength and magnetism. Attempts to optimise the conductive properties of iron alloys whilst retaining their strengthened magnetic properties have included, for example, forming homogenous alloys including iron and copper. However, such alloys tend to represent a compromise in which the advantageous properties of each element or alloy species are diminished.

It would therefore be advantageous to provide a metal structure made predominantly of iron alloy without compromising on properties of thermal and electrical conductivity.

Methods of attaching dies to the chase have, as described above included clamping means where the dies used, do not contain ferro-magnetic material. It would also be an advantage to the industry to be able to accommodate pre-existing non-ferro magnetic material containing dies so that old stock is not made redundant and costly replacements are therefore not required.

The above description of the prior art is not intended to be, nor should it be interpreted as, an indication of the common general knowledge pertaining to the invention, but rather to assist the person skilled in the art in understanding the developmental process which lead to the invention.

Accordingly there is a need in the industry for an arrangement which ameliorates one or more of the abovementioned disadvantages.

### DISCLOSURE OF THE INVENTION

In one broad form, the invention provides a magnetic holding device including:

a) a support structure made of an iron alloy and having a substantially planar bearing surface;

b) at least one magnetic or magnetisable region located in said support member; and

c) insulating means made of non-magnetic material interposed between said region and said support structure to resist magnetic induction of, or leakage to, said support structure.

The magnetic holding device may include a range of shapes and configurations depending on the application. For example, where the magnetic holding device is used as a spacer plate in graphic art design processes, the magnetic holding device is preferably in the form of a plate. The magnetic holding device may include two opposed planar surfaces. The magnetic holding device may be square, rectangular or any other shape suitable to the application. In its most common application in graphic art design processes, the magnetic holding device will be in the form of a planar rectangular plate.

The magnetic holding device may vary in its dimensions. For example, in its application as a spacer plate in graphic art design processes the magnetic holding device is preferably between about 4 mm and 6.5 mm thick, depending to a large extent on the thickness of the die to be attached thereto. In other applications, the thickness of the magnetic holding device may vary considerably depending on spacial constraints and the magnetic flux density required in each particular case.

Depending on the dimensions of the graphics art design required to be produced, the bearing surface of the spacer plate may include sizes of about 210×150 mm (A5 size), 300×210 mm (A4 size) or 420×300 mm (A3 size).

The support structure in general terms defines the dimensions of the magnetic holding device. The support structure includes one or more bores adapted to receive the one or more magnetic or magnetisable regions. Preferably, the support structure is made of steel. Depending on the application, the support structure may be made of mild steel, case-hardened steel, stainless steel and the like.

Even magnetic holding devices made of steel will eventually become distorted to the extent that they are no longer useful. However, a steel support structure will be considerably more durable than present alternatives by a factor of between 20 and 30 times. As a person skilled in the art will appreciate, softer metals will exhibit less fatigue but more malleability and harder metals will exhibit greater resistance to distortion over time, but may exhibit higher instances of fatigue. Accordingly, the iron alloy used will vary in iron, carbon, copper, zinc, etc. content depending on the application.

The at least one magnetic or magnetisable region may include a magnetisable core subject to an electric field to induce magnetism or may be in the form of a permanent magnet. The magnetisable region may be useful in applications where the application of intermittent magnetic force is required, For example, in graphic art design processes it may be useful to place a die on the magnetic holding device in suitable alignment as required and then apply the magnetic force to hold the die in fixed position until the production run is completed. The power may then be cut off to release the die. However, it may be more convenient in many applications to use permanent magnets to form the magnetic region.

In a preferred form of the invention, the magnetic holding device includes a plurality of magnetic or magnetisable regions in spaced relationship with one another. Depending on the application and the relative magnetic field intensity required, the following factors may be varied:

1. The diameter of the or each region;

2. The depth of the or each region;

3. The separation between regions;

4. The orientation of the magnetic poles to vary the magnetic field intensity surrounding the one or more regions.

5. The particular material used for the magnetic region or the amount of current carried by conductors in the case of magnetisable regions.

Preferably, the one or more magnetic or magnetisable (hereinafter referred to as “magnetic regions”) regions have a diameter of 2-10 mm. Still more preferably, the at least one magnetic region has a diameter of 3-6 mm. Magnetic field intensity per unit volume of magnetic material is maximised by have a plurality of tightly spaced magnets of small diameter. The depth of the magnetic region may vary with and correspond substantially directly with the thickness of the support structure.

Alternatively, the depth (in the case of a region having a substantially cylindrical shape, the axial length) may be less than the thickness of the support structure. Accordingly, the bore in which the magnetic region resides may be in the shape of a cup, channel or block. In a preferred form the magnetic region and the bore in which it resides is cylindrical. The separation between magnetic regions may vary considerably depending on the application and is almost indefinable. For most applications, however, the distance separating the adjacent magnetic regions will fall within the range of 5-25 mm, with 6-8 mm preferred.

The plurality of magnetic regions may be orientated so that the north poles are coplanar. Alteratively, the magnetic regions may be grouped so that members within each group share the same pole in a common plane but have opposite poles to each adjacent group. In yet another alternative, adjacent magnetic regions may have opposite poles whereby to maximise the magnetic field intensity of any particular point on the bearing surface of the magnetic holding device.

The insulating means may be made from a wide range of non-magnetic materials effective to insulate the support structure against direct magnetic leakage. Of course, a person skilled in the art will appreciate that some magnetic induction of the support structure will occur which may be desirable to enhance the distribution of magnetic field across the magnetic holding device without significant dissipation of magnetic flux beyond the magnetic regions.

The magnetic region may include a magnetic surface which lies close to or flush with the planar bearing surface. Preferably the magnetic surface lies flush with the planar bearing surface to maximise the magnetic force applied to a work piece, such as a steel backed die. Alteratively, the magnetic surface may lie just beneath the plane of the planar bearing surface to reduce the incidence of fatigue in the magnetic regions which may be sustained during a graphic art design process.

The insulating means may be made of any suitable magnetic material, for example, the insulating means may be made from non-magnetic metals such as copper, brass, zinc or aluminium, copper alloys, aluminium alloys, magnesium alloys, nickel, titanium, or from other materials including polymeric materials including tempered glass fibre, metal fibre, carbon fibre or graphite fibre.

The polymeric materials must necessarily possess high impact resistance characteristics and be able to withstand relatively high temperatures up to around 160 to 210° C., more typically around 180° C. The polymeric material may include a thermoset resin selected from the group including allyl polymers, epoxy polymers, furan, melamine formaldehyde, melamine phenolic polymers, phenolic polymers, polybutyldiene polymers, thermoset polyester and alkyd polymers, thermoset polyamide polymers, thermoset polyurethane polymers, flexible thermoset silicone polymers, silicone epoxy polymers and thermoset ureapolymers.

However, copper alloy is a preferred material for forming the insulating means, due to its relative strength, the ease with which it may be worked, and its excellent magnetic insulation properties.

The insulating means may be in the form of a tube where the magnetic region extends from one face of the support structure through to its opposite face or in the form of a cup where the bore in which the region resides does not extend entirely through the support structure.

In the case where the insulating means is made from metallic material, heat distribution throughout the magnetic holding device may be relatively uniform. A support structure made of iron alloy is a relatively poor heat conductor. Due to the relatively high resistance to heat transfer of iron alloys, the ultimate result is a uniform distribution of heat throughout the structure.

Where the insulating means is made from a non-magnetic metal or metal alloy such as copper, the heat transfer co-efficient of the material may be considerably higher than for that of the support structure generally made from an iron alloy. Accordingly, a uniform heat distribution may be obtained throughout the magnetic holding device effective for use, for example, in a hot stamping process.

In the case of non-metallic insulation means, heat transfer may occur between the support structure and the end surface of the magnetic region remote from the planar bearing surface, whereby uniform heat distribution is achieved throughout the magnetic holding device with the exception of the insulating means. It will be appreciated by persons skilled in the art that the effect of the insulating means being relatively colder than the rest of the magnetic holding device may be relatively minor and not sufficient to adversely effect the efficiency of a hot stamping process, particularly where the distance between the support structure and the magnetic region corresponding to the thickness of the wall of the insulating means is small.

In a preferred form of the invention the magnetic holding device is nickel plated, to provide resistance against rusting and scratching, due to the superior characteristics of nickel.

Furthermore, to enhance and improve heat conductivity generally in spacer plates according to the invention, it has been found that additional solid copper or brass rods may be utilised in addition to the insulated magnetic regions. These do not weaken the steel structure and assist instead to uniformly distribute the heat across the plate. In hot foil stamping presses where greater heat capabilities exist, advantage may be had to the extent that heat is more uniformly and quickly dissipated resulting in improved efficiency through reduced cycle times, that is to say increasing the speed of stamping.

It will also be found useful when utilising magnetic spacer plates according the invention in presses employing cylinders, that retention of the magnetic base will be improved where feet are made available at each corner for engagement with the so-called honeycomb structure of the standard chase. This follows since the sheer volume of metal in the cylinder of such presses tends to cause the magnetic plate to be raised as the cylinder rolls. Provision of the feet to engage in the already existing honeycomb structure of the chase alleviates such dislodgement.

The invention, in another broad form, also provides a method of manufacturing a magnetic holding device including at least one magnetic body located in a support structure, said method include the steps of:

a) forming at least one bore in said support structure, said support member being made from a hard iron alloy and having a substantially planar bearing surface;

b) inserting insulating means made from non-magnetic material into said bore, said insulating means defining a hole substantially coaxial with said bore; and

c) inserting the magnetic body into said hole,

wherein said insulating means is interposed between said magnetic body and said support structure to resist magnetic induction of, or leakage to, said support structure.

The invention, in yet another broad form, also provides a method of manufacturing a magnetic holding device including at least one magnetic body located in a support structure, said method including the steps of:

a) forming at least one bore in said support structure, said support structure being made from an iron alloy and having a substantially planar bearing surface;

b) inserting said body into insulating means to form an insulated body having an internal magnetic core surrounded by non-magnetic insulating means; and

c) inserting said insulated body into said bore, wherein said insulating means is interposed between said internal core and said support structure to resist magnetic induction of, or leakage to, said support structure.

The bore may be formed in the support structure by any one of a range of means familiar to the person skilled in the art. Preferably, the bore is formed by machining the support structure. The bore may extend entirely through the support structure or may extend part way through to form a recess. The magnetic body may be any shape or configuration such as block, square, rectangular or triangular shaped. However, the magnetic body is preferably cylindrical or disc-shaped, whereby the bore is correspondingly cylindrical or cup shaped.

The magnetic body may be inserted into the insulating means using a wide range of methods. For example, the magnetic body and the insulating means may be correspondingly threaded or otherwise grooved whereby to mutually engage. However, preferably the magnetic body is press fitted into the insulating means. Preferably the magnetic body is bonded into the insulating means by utilising an adhesive or other chemical compound including for example Loctite®. Similar principles apply to the insertion of the insulated body into the bore. Preferably, the insulated body is press fitted into the bore, relying on the malleability of the insulating means to ensure a tight fit. Again improved retention may be achieved with the use of compounds such as Loctite®.

The insulating means may comprise bores which vary in thickness depending on the application. The insulating means wall must be sufficiently thick to provide effective resistance against magnetic induction occurring between the internal core and the support structure. Accordingly, the wall thickness of the insulating means may vary between 10 μm and 3 mm.

In a particularly preferred embodiment, the outer wall of the insulating material is provided with a step or steps to help prevent the insulated magnetic core from being prematurely ejected from the magnetic plate under pressure from constant use. In other words, there is tendency for the failure of the magnetic plate to occur when subjected to constant use by virtue of the forces used thereon to push the insulated magnets therefrom from time to time. Providing a step in the insulating material significantly reduces this effect. This step will be provided on the underneath or bottom side of the insulated magnet.

Preferably the bearing surface of the magnetic holding device is substantially smooth and planar. Accordingly, preferably the planar bearing surface is ground using a grinding machine to render the bearing surface substantially planar. Preferably the underside of the magnetic holding device is also ground to ensure a uniformly flat surface thereunder as well.

As mentioned before, it would be advantageous to provide a metal structure made predominantly of iron alloy without compromising on properties of thermal and electrical conductivity. Accordingly, in a further embodiment the invention there is provided a metal conductor including:

a support structure made of an iron alloy;

a first region made of a relatively poor thermal and electrical conducting metal located in said support structure; and

a second region made of a relatively good thermal and electrical conducting metal surrounding the first region from the support structure, whereby the rate of thermal and electrical conductivity of the metal conductor as a whole is better than the rate of the thermal or electrical conductivity of the second region material alone.

The metal conductor may be a thermal conductor and/or an electrical conductor. Clearly, as the person skilled in the art will appreciate, in most cases the conductor will display strong properties both as a thermal and as an electrical conductor.

The support structure may be in the form of a variety of configurations. For example, the support structure may be cylindrical, corrugated, regular, spherical, block-shaped or planar. The configuration of the support structure depends on the application. In the case of a hot foil stamping process, the support structure will be predominantly planar or cylindrically shaped. In the case of heating applications such as hot plates, the support structure may be predominantly concave, as in the form of a crucible, spiral shaped, made up of concentric rings or planar, depending on the type of items required to be heated. In the case of electrical cable, the support structure may be in the form of elongated cable.

Depending on the application, the support structure may be made of steel. For example, the support structure may be mild steel, case-hardened steel, stainless steel, carbon-steel or the like.

The second region may be made from a variety of good thermal and/or electrical conducting materials. For example, copper, nickel, silver, gold, aluminium, zinc, magnesium, titanium, or a combination of two or more of the aforementioned, which may be used to form alloys such as copper alloys including brass, aluminium alloys and magnesium alloys. These materials will generally exhibit high thermal and electrical conductivity. It is preferable that the second region also possess good magnetic insulating materials. Copper or brass are generally preferred, due to their high thermal and electrical conductivity, good magnetic insulation properties, satisfactory strength and hardness and their relative low cost and ready availability.

Accordingly, in a particularly preferred form, the invention provides a metal conductor including:

a support structure made of an iron alloy;

a first magnetic or magnetisable region located in the support structure;

a second region made of a relatively good thermal and electrical conducting metal surrounding the first region,

whereby the rate of thermal and electrical conductivity of the metal conductor as a whole is better than the rate of thermal or electrical conductivity of the second region material alone.

The poor conducting metal of the first region includes metal alloys comprising a large proportion of iron and other elemental components similarly possessing poor heat and/or electrical conducting properties. In the case of alloys having a high iron component, the poor conducting metal may be magnetised as described herein. Suitable poor conducting metals include samarium cobalt (SmCo¹⁷) having a magnetic flux of 16-32 MGOe (Mega Gauss Orsted) and neodymium-iron-boron (NdFeB) with an MGOe of 24-48. In higher temperature applications where a high value of magnetic flux is required to be retained at elevated temperatures, SmCo¹⁷ is most preferred because of its low temperature of remanence.

The first region may comprise a plurality of separate regions forming islands each surrounded by a second region and set in the support structure. The first regions may be irregularly or randomly scattered throughout the surface of the support structure. Alternatively, the first region may comprise a regular array of such islands. For example, the first region may comprise a plurality of non-interconnecting lines which may be parallel or angled relative to one another. The first region may comprise a series of curved lines of identical radius or rate of curvature such that they are parallel or, alternatively, forming a radiating wave pattern in which the lines have incrementally increasing radii. The first region may comprise islands of poor conducting metals or magnetic or magnetisable materials arranged in grid patterns, hexagonal patterns, or the like. The first region may comprise a single spiral or discreet concentric rings of ever increasing radii. The first region may comprise a plurality of square or rectangular elements of ever increasing dimension extending outwardly from a smallest central element.

Depending on the application and the ratio of conductivity to strength or magnetism of the metal conductor, the following factors may be varied:

1. the dimensions of each region forming part of the first region;

2. the depth of each region forming part of the first region relative to the thickness of the support structure;

3. the separation between the regions forming part of the first region;

4. in the case of the first region being formed from ferromagnetic material which may form permanent magnets, the orientation of the magnetic poles to vary the magnetic field intensity surrounding the one or more regions forming part of the first region; and

5. the particular material used to form the first region.

Preferably, the first region is made from ferromagnetic material and is in the form of a plurality of discreet solid cylinders or plugs arranged in a regular array flush with the surface of the support structure. Preferably, the plugs extend from one external surface of the support structure to an opposed external surface.

The invention in another embodiment provides a magnetic holding device including:

a) a support structure made of an iron alloy including one or more recesses and having a bearing surface;

b) at least one magnetic or magnetisable region located in said recess of said support structure; and

c) insulating means made of non-magnetic material interposed between said region and said support structure to resist magnetic induction of, or leakage to, said support structure from said region.

The bearing surface may be in the form of a variety of configurations. For example, the bearing surface may be in the form of a planar, cylindrical or otherwise curved surface. In hot foil stamping applications, the bearing surface will generally be planar or cylindrical.

In still another aspect of the invention there is provided a metal conductor including:

a support structure made of an iron alloy;

first poor conducting regions made of metal located in said support structure;

second good conducting regions, each second good conducting region made of metal which surrounds one of the first regions from the support structure; and

a third good conducting region intermediate at least two of the second good conducting regions,

whereby the rate of thermal and electrical conductivity of the metal conductor as a whole is better than the rate of the thermal and electrical conductivity of the material of the second or third good conducting regions alone.

The third good conducting region is preferably isolated from the second good conducting regions. The third region is preferably embedded in the support structure.

The support structure may include bores extending partially or fully from one face to an opposed face. The support structure may include some partially extending and some fully extending bores. Preferably, in the case of a planar metal conductor, the bores extend fully from a bearing face to an opposed face.

The third region may be fixedly seated or inserted in a bore in the support structure. Preferably, the first, second and third regions are arranging in a regular array. The third region may be equidistant relative to adjacent second regions.

The third region may include a plurality of islands intermediate the second regions. The islands may be of consistent dimensions. Alternatively, the islands may include two or more different dimensions. The islands may be a variety of shapes. The islands may be rod-like, plate-like, cylindrical, conical, truncated conical, square or rectangular box-like.

Preferably the islands are cylindrical. The islands may be made from any non-ferrous metal or metal alloy such as copper or brass or any material of which the second region may be made.

The metal conductor may include a range of sizes depending on the application. For example, in the case of a planar metal conductor, it may come in sizes such as A4 (210×297 mm), A5 (148×210 mm), A6 (105×148 mm) or B1 (74 mm×105 mm). The depth or thickness of the metal conductor may also vary with the application. For example, where the metal conductor is for use in hot foil stamping processes it is preferable that the metal conductor conform with the dimensions of existing machinery. Where existing machinery is designed for use with 7 mm or ¼ inch dies the thickness of the metal conductor may be 1.3 mm less to allow for the thickness of 1.3 mm thick dies thereon.

The metal conductor may be formed from sub-units. Two or more individual metal conductors may be combined to present a larger unitary top bearing surface, the sum of the individual sub-units. Where the metal conductors are plates, the plates may be abutted side by side to present a substantially seamless top bearing surface. At least one peripheral edge of each sub-unit may include alignment means to ensure the correct alignment of the sub-units and, optionally, the engagement of one sub-unit to an adjacent sub-unit. The alignment means may include male or female components, such as a male components on a first sub-unit and a female component on a second sub-unit. The alignment means may include tongue and groove, a pin and hole, rail and slot arrangements or any other suitable protrusion and recess combination. The sub-units preferably exhibit little lateral magnetic attraction or repulsion to enable easy coaction of one sub-unit with another.

In yet another aspect of the invention there is provided a method for aligning a die having a top peripheral surface adjacent a relief surface to a magnetic holding device as described herein having a bearing surface in a graphic art design process including:

a) aligning said magnetic holding device on a ferrous metal support;

b) aligning said die on said magnetic holding device; and

c) securing said die to said magnetic holding device by applying to said top peripheral surface and to said bearing surface a length of single sided adhesive tape,

wherein the adhesive is sufficiently strong to ensure that said die remains in position during said graphic art design process.

The die may include a range of configurations and materials which are in common use in the industry. The die may include brass, copper, magnesium, aluminium, zinc, or polymeric (or composites thereof), optionally 0.5 mm to 2 mm or 1/32 to 1/16 inch thick with the relief surface standing proud above the line of the remaining top surface of the die. Such dimensions are suitable for use in the present inventive method.

Due to their relative thinness, they are vulnerable to bending and permanent damage, particularly when adhered to a chase or other support using a curable adhesive, as is common in the industry, for example, a die affixed to a chase or other support using double backed adhesive tape. Such adhesive tends to cure when exposed to high temperatures (above, say 140° Celsius) causing the die to be stuck fast to the chase or other support. Damage to the die can subsequently occur as a result of attempts to firstly remove the die from the chase or other support and subsequently to remove any cured adhesive adhered to the surface of the die or to the chase or other support.

As a result of the cured adhesive sticking fast to the die, a wafer thin die may be irreversibly bent rending it useless for future production runs. Dies having a standard thickness of a ¼ inch or 7 mm depending on the jurisdiction, are less vulnerable to bending but nonetheless suffer from cured adhesive sticking fast to the surface thereof often rendering the die useless for future production runs.

For the purpose of the present invention, pre-existing stocks of dies with a standard thickness of ¼ inch or 7 mm may be cut to low tolerance using a wire cutter or laser to bring them within the dimensions useful to the invention (namely a thickness of about 1.3 mm or 1/16 inch).

The top peripheral surface may extend only along one edge of the die. Preferably, however the top peripheral surface extends around the entire top surface of the die. The top peripheral surface may be recessed to permit the application of tape on its surface without rising above the line of the surface on which the relief is located (“the relief surface”). The top peripheral surface may be between 5 mm and 50 mm wide, preferably being about 10 mm to 20 mm wide. The depth of the recess would depend on the thickness of the tape being used, but as a general guide may be between 0.1 mm and 2 mm deep.

The relief surface is preferably central to the top surface of the die and is of a dimension and nature well known in the art and dependent on the nature of the graphic art to be produced.

The magnetic holding plate may be in accordance with the magnetic holding device described above. The magnetic holding plate provides an easily manipulable support for bearing the die, particularly when handling the die during a graphic art design process involving high temperatures. Accordingly, advantageously the magnetic holding plate has sufficient magnetic flux to stably adhere to the chase without being displaced during a production run, but is sufficiently movable by standard manual tools to achieve desired alignment of the die preparatory to a production run. To this purpose, it may be desirable in some applications to have a magnetic holding plate of smaller plan proportions whereby to minimise the magnetic force applied by the magnetic holding plate to the chase as a whole.

As a person skilled in the art will appreciate, a magnetic holding plate with a plan surface area the size of an A4 sheet will be far more difficult to manipulate and correctly align than progressively an A4, A5 or B1 sized magnetic holding plate. Accordingly, in some applications it may be preferable to utilise a combination of two or more magnetic holding plates of smaller dimensions which are separately easily manoeuvrable, but which may be combined to form a larger unitary bearing surface on which the die may be mounted. Accordingly, the magnetic holding plate may be formed from a plurality of sub-units.

The sub-units may include alignment means. The alignment means may be located along one or more peripheral edges of the sub-unit. Adjacent sub-units may include complementary alignment means. The alignment means may effectively provide engagement means which may be releasable when it is required to separately manipulate and re-align or remove one or more of the sub-units from the chase. The alignment means may include male and female components. The alignment means may include tongue and groove, protrusion and hole, flange and slot, rail and recess arrangement and the like.

The peripheral edges of the sub-units may be cut to low tolerance by a high precision cutting implement, such as a wire cutter or a laser cutter, so that on abutment with an adjacent sub-unit, the top bearing surface presented to the die is virtually seamless.

The tape may be high temperature resistant and suitable for use in a hot foil stamping process or any other graphic art design process involving elevated temperatures. The adhesive used is preferably of a type that will not cure at the operating temperatures during the process and is easily removed without leaving residue. The backing of the tape may be a polymeric film such as polyamide or polyester, glass cloth tape, crepe paper masking tape, such as smooth or mini or thicker crepe paper.

Polyamide backing may be used in applications requiring performance stability at high temperatures. Glass cloth backing may be useful where dies are subject to some shearing forces, such as may be experienced where the stamping process involves a cylindrical drum rather than a linearly reciprocating stamping means because of the relative high tensile strength of glass cloth backing. It may also be useful at extremely high temperatures. Polyester film backing will be useful in applications involving very long production runs due to its abrasion, chemical and thermal resistance under wide-ranging conditions.

The adhesive may include silicone adhesive for high temperature resistance and easy removal without leaving residue on the die or magnetic holding device.

The adhesive may satisfactorily have a fairly low adhesion to metallic and plastic surfaces. For example, an adhesion of between 32 and 50 oz./in (35 N/100 mm to 54 N/100 mm) to a steel surface would be sufficient for most applications. The reason for the relatively low adhesion requirement is that the collective application of tape to the top peripheral surface of the die is generally sufficient to keep the die in place and also serves to permit easy removal and realignment of the die should it be desirable without leaving unwanted adhesive residues. For this purpose, it is desirable that the adhesive be adapted to be reapplied many times over and that the adhesive be strongly resistant to curing.

Preferably the method for aligning the die includes the further steps of:

e) carrying out the graphic art design process; and subsequently

f) peeling the tape off the top peripheral surface and the bearing surface,

such that no adhesive residue remains on the top peripheral surface or the bearing surface and the die is not damaged by peeling of the tape in step f).

The die may be in the form of a thin wafer about 1.0 mm to 1.75 mm, and preferably 1.3 mm or 1/16 inch in thickness.

The top peripheral surface may be recessed relative to the relief surface to ensure the tape does not interfere with the graphic art design process. Accordingly, the height difference between the recessed top peripheral surface and the supporting surface for the relief (“the relief surface”) is greater than or equal to the thickness of the tape.

Where the die has an original thickness greater than that desired for the graphic art design process, such as ¼ inch or 7 mm, the method for adhering the die may further include a preliminary step involving cutting the die to a thickness of substantially 1.3 mm or 1/16 inch.

### BRIEF DESCRIPTION OF THE DRAWINGS

The invention shall be better understood from the following, non-limiting description of preferred forms of the invention, in which:

FIG. 1 is a perspective view of a magnetic holding device according to one aspect of the invention;

FIG. 2 is a top plan view of a magnetic holding device showing a range of possible arrangements;

FIG. 3 is a side elevation of a magnetic holding device according to a first embodiment of the invention;

FIG. 4 is a side elevation of a magnetic holding device according to a second embodiment of the invention;

FIG. 5 is a side elevation of a magnetic holding device according to a third embodiment of the invention;

FIG. 6 is a schematic representation of a particular embodiment utilising alignment means for aligning as described herein;

FIG. 7 is a schematic representation of a further embodiment utilising alignment means as described herein;

FIG. 8 is a section view of a first embodiment of a metal conductor according to one aspect of the invention;

FIG. 9 is a section view of a second embodiment of a metal conductor according to one aspect of the invention;

FIG. 10 is a section view of a third embodiment of a metal conductor according to one aspect of the invention;

FIG. 11 is a plain view of a fourth embodiment of a metal conductor according to one aspect of the invention;

FIG. 12 is a perspective view of a fifth embodiment of a metal conductor according to one aspect of the invention;

FIG. 13 is a schematic plan view of a sixth embodiment of a metal conductor according to one aspect of the invention;

FIG. 14 is a schematic plan view of a seventh embodiment of a metal conductor according to one aspect of the invention;

FIG. 15 is a schematic plan view of an eighth embodiment of a metal conductor according to one aspect of the invention;

FIG. 16 is a graph showing the comparative results of a heat transfer rate test;

FIG. 17 is a graph showing the comparative results of a second heat transfer rate test;

FIG. 18 is a graph showing the results of a test concerning the disruption of magnetic holding power;

FIG. 19 is a graph showing the comparative results of a test for the force required to dislodge a magnet at ambient temperature; and

FIG. 20 is a graph showing the comparative results of a test concerning the force required to dislodge a magnet at 160° C.

### BEST MODE OF CARRYING OUT THE INVENTION

It should be noted in general that the drawings are schematic and not drawn to scale.

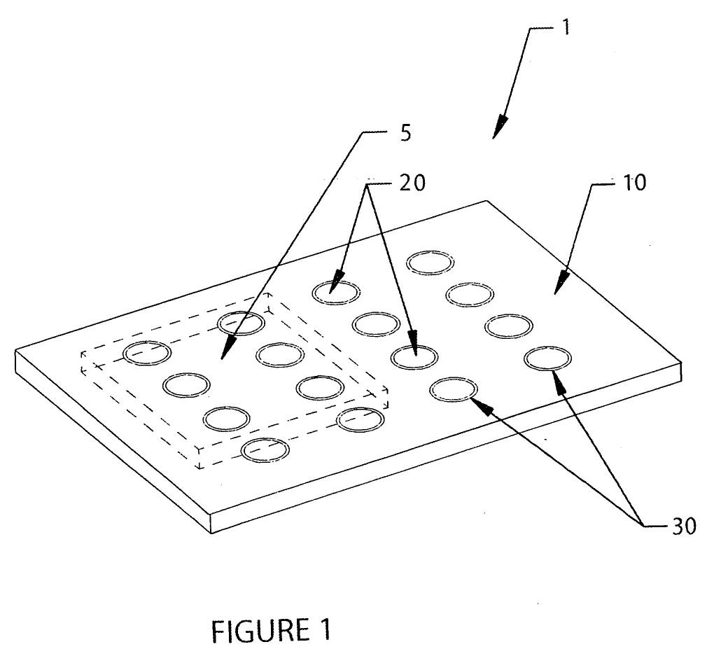

Referring to FIG. 1, there is shown a magnetic holding device 1 including a steel spacer plate 10 and a plurality of spaced magnets 20 arranged in a grid pattern.

The spacer plate 10 has a specific thickness whereby to act as a spacer in a hot stamping process involving the use of steel-backed photopolymer die 5 shown in dotted outline. The die 5 typically includes a thin sheet of steel adapted to be magnetically releasably fixed to the spacer plate 10 with the steel plate facing down and in direct contact with the spacer plate 10. The upper surface of the die 5 is coated with a polymeric material defining a design image for use in hot foil stamping. The die 5 is typically about 1.0 mm-1.9 mm thick. Consequently, the spacer plate 10 will be of a thickness of about 4.45-5.35 mm in the US and 5.1-6.0 mm elsewhere.

The support plate 10 is made from steel making it extremely resistant to deformation on being subjected to repeated high impacts commonly associated with hot stamping processes. Unlike the spacer plates of the prior art made from non-ferrous metal materials which are prone to deformation over time, the spacer plate 10 made of steel displays superior impact-resistant properties.

Each magnet 20 is insulated from the spacer plate 10 by insulating means 30. The insulating means 30 is made of a copper alloy which insulates the magnet 20 against magnetic inductance to the spacer plate 10. The insulating means 30 is in the form a tube of copper alloy having a wall thickness of about 1 mm.

Due to the relative current day costs of steel compared to copper alloys or brass, there is a considerable cost advantage in making the spacer plate 10 out of steel. However, it is advantageous to surround the magnet 20 with albeit expensive copper alloy or another relatively soft non-magnetic metal because of its excellent magnetic insulation, maleability and heat transfer properties.

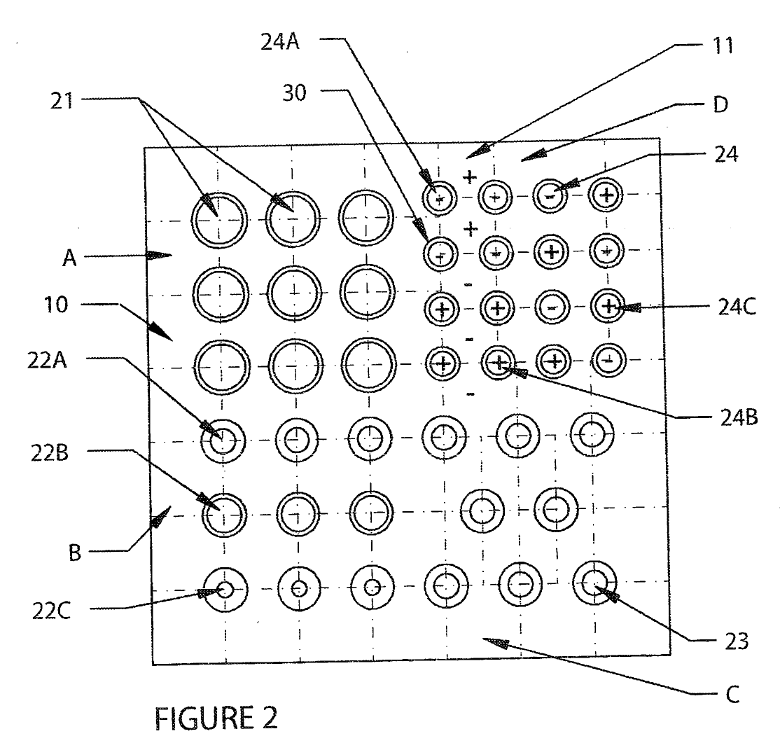

Referring to FIG. 2, there is shown a magnetic holding device displaying a range of optional arrangements of permanent magnets 20. The different arrangements are presented on the one magnetic holding device 1 in order to conveniently describe the options available and it should be noted that any one magnetic holding device 1 would normally have the permanent magnets 20 arranged in a uniform pattern or array.

In the zone designated “A”, there is shown nine large permanent magnets 21 arranged in a regular grid pattern in which each of the permanent magnets 21 are equi-spaced from the respective adjacent magnet 21.

The permanent magnets shown in zone “B” illustrate that a wide range of permanent magnet diameters and insulation means wall thicknesses may be suitable for different applications. Permanent magnets 22a may be moderate in size (for example, 6 mm in diameter), and have insulation means 32 wall thickness of about 1 mm.

Permanent magnets 22b may be larger in diameter, (for example, 10 mm in diameter), and have insulating means 30 wall thickness as small as 10 μm, provided that the integrity of the wall of the insulating means 30 is maintained and provides an effective barrier to direct magnetic inductance from the permanent magnet 22b to the spacer plate 10.

Magnets 22c illustrate that the magnets may be as small in diameter as 2 mm and the insulation means wall thickness may be as large as 3 mm. In general terms, magnetic field intensity is maximised by providing magnets 20 of small diameter in a closely spaced array. However, closely packed arrays may be labour-intensive to manufacture and costly in terms of materials.

As shown in zone “C” the permanent magnets 23 may be arranged in non-grid patterns or irregular arrays. In some applications, it may be helpful to have a central concentration of magnets 20 capable of securely holding a die 5 in position and to provide a less concentrated array of magnets 20 corresponding to the location of the peripheral edges of the die 5 to enable manipulation of the die 5.

Zone “D” illustrates that the orientation of the poles of the magnets 24 in a particular array may be important in maximising the magnetic force to be applied to the die 5. An array of magnets 24a with all negative poles orientated upwards is effective to induce positive polarity in the surrounding regions of the spacer plate 10 which will be referred to as the support structure 11. Conversely, arranging all positive poles of magnets 24b with an upward orientation is effective to induce negative polarity in the surrounding material of the support structure 11. As will be appreciated, the material of the surrounding support structure 11 is only weakly induced due to the effective resistance to same by the insulation means 30.

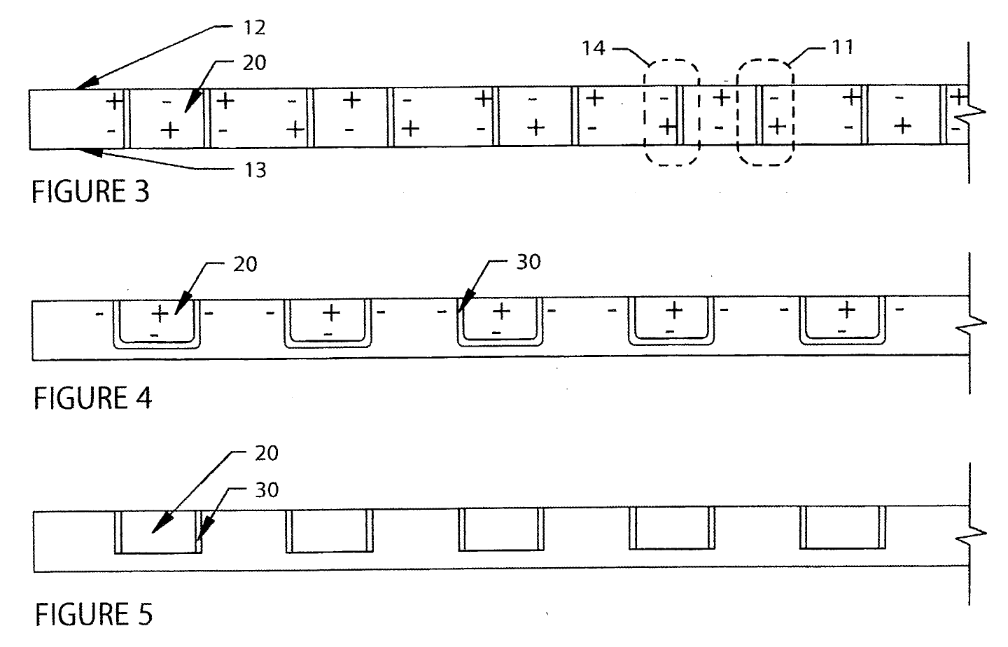

The strongest magnetic flux field in the region of an array of magnets 24c is obtained by alternating their polarities such that, at the bearing surface 12 (refer to FIG. 3) the polarity of each magnet 24c is opposite to the polarity of each adjacent magnet in the array. Such alternating polarity increases the complexity of the weakly induced magnetic polarity surrounding each magnet 24c, such that the weakly induced polarity of the material of the support structure 11 immediately surrounding each magnet 24c is opposite to the polarity of that magnet 24c.

With reference to FIG. 3 there is shown a first preferred embodiment of the magnetic holding device of the invention in which the bores into which each shrouded magnet 20 is inserted extends completely through from the bearing surface 12 to the underside surface 13 of the magnetic holding device 1. FIG. 3 further illustrates the arrangement of magnets 20 in which the magnetic polarities are alternatingly oppositely orientated whereby to weakly induce the immediately surrounding support structure 11 to correspondingly have the opposite polarity. The shape of the magnetic field 14 is schematically illustrated in FIG. 3 as an “opposed ear-shaped” configuration affecting the polarities of the weakly induced regions of the support structure 11.

In FIG. 4 there is shown a second embodiment of the invention in which the sheathed magnets 20 are retained in cup-like bores which do not extend right through the support structure 11. It is preferred in this embodiment that the insulating means 30 is made from a metallic material such as copper alloy or brass to ensure adequate beat transfer from the support structure 11 to the regions occupied by the magnets 20 to ensure uniform and effective heat transfer to the die 5 in a hot stamping process.

FIG. 5 shows a third embodiment in which the magnets 20 are retained in bores which do not extend entirely through the support structure 11 but form a recess for the magnets 20 to reside therein. In this embodiment the insulating means 30 is in the form of a tube 30 which insulates only the side walls of the disc-shaped magnet 20.

The strength of the magnets 20 is expressed in terms of the amount of magnetic flux available from a unit volume of the magnet material and is generally described in units of MGOe (mega gauss orsted). As the person skilled in the art will appreciate, a range of magnetic materials may be used. Where hot stamping processes are involved requiring efficacy of the magnet material at temperatures around 140°-160° Celsius, it is important that the material have superior heat remanence properties in this temperature range. Such materials include samarium cobalt (SmCo¹⁷) having an MGOe of 16-32 and neodymium-iron-boron (MdFeB) with an MGOe of 24-48. SmCo¹⁷ is most preferred because of its low temperature of remanence which makes it suitable for option at higher temperatures such as those associated with hot foil stamping processes.

In operation the spacer plate 10 may be carefully aligned on the chase of a hot foil stamping machine (not shown). The spacer plate may have recesses (not shown) on each of its four underside edges. Non-alignment of the spacer plate 10 may be corrected with the aid of an industrial fork adapted to coact with one of the recesses to disengage the spacer plate 10 from the chase and permit re-alignment. The die 5 may then in turn be carefully aligned on the spacer plate's bearing surface 12. After the production run is carried out the die 5 may generally be removed by hand. The magnetic forces retaining the spacer plate 10 on the chase require the use of the industrial fork to effect its removal from the chase as mentioned above.

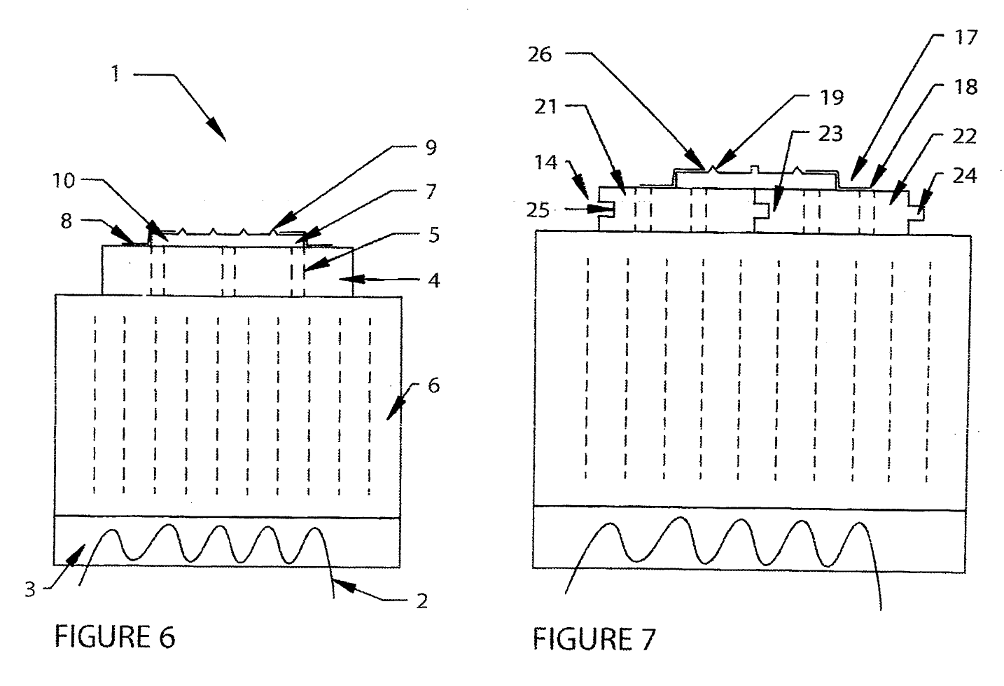

In FIG. 6, there is shown a stamping arrangement 1 for a hot foil stamping process, the arrangement 1 including a heating element 2 embedded in a heater bed 3 on which rests a honeycomb chase 4 adapted to efficiently transfer an even heat from the heater bed 3 to a magnetic holding device 4 resting on the chase 3. The magnetic holding device includes magnets 5 shown in dotted outline therein enabling the magnetic holding device 4 to be securely affixed to the chase 6 by a magnetic attraction. A non-ferro magnetic material containing die 7 is aligned in position on the magnetic holding device 4 and secured in position using single sided adhesive tape 8.

The tape 8 suitable for the purpose includes very specific properties not previously considered in the industry to be suitable to a graphic art design process, particularly a hot foil stamping process. Previous tapes used included double sided tape including a heat curable resin which had the tendency to cure over time and during the progress of a production run thereby rendering the die unusable due to the difficulty in removing the tape without damaging the die. The tape 8 suitable to the invention has only mild adhesion properties making it easily removable for the purpose of either realigning the die 7 or removing the die from the magnetic holding device 4 entirely at the completion of a production run. Such an adhesive tape 8 was not considered suitable because of these very low adhesion properties as traditional wisdom has taught that the forces involved in stamping, embossing and the like require the die to be strongly adhered to the support such as the magnetic holding device 4 or chase 6. It has been surprisingly found that the use of a low adhesion tape 7 is satisfactory and, in fact, preferable as it secures the die 7 against lateral shifting and linear displacement is unlikely in a stamping or other graphic art design process.

As can be seen in FIG. 6, the die 7 includes a central top surface region having a relief 9 which extends above the line of the upper surface of the adhesive tape 8 attached to the top peripheral surface region 10 of the die 7.

Referring now to FIG. 7, the magnetic holding device 14 comprising a first sub-unit 21 and a second sub-unit 22. The sub-units 21, 22 are virtually seamlessly abutted together using a tongue and groove arrangement 23. It can be seen that the sub-units 21, 22 are identical and have a tongue component 24 and a groove component 25 along the opposite edge. By combining sub-units 21, 22 one can form a larger magnetic holding device 14 having a plan bearing surface which is the sum total of the sub-unit 21, 22 bearing surfaces and can be used to support a die 17 larger in plan area than the bearing surface of a single sub-unit 21, 22. The die 17 includes a relief 19 elevated relative to the surrounding top peripheral surface 26 of the die 17. To accommodate a tape 18 the thickness of which would be such as to interfere with the graphic art design process, the top peripheral surface 26 is recessed relative to the relief surface area 19 so that the relief surface 19 is clearly proud of the top peripheral surface area 26.

It can be understood that in using the method according to the invention, if the die 7, 17 is misaligned, the tape 7, 17 may be lifted, the die readjusted for preferred alignment and the tape 8, 18 reapplied to secure the die in preferred alignment.

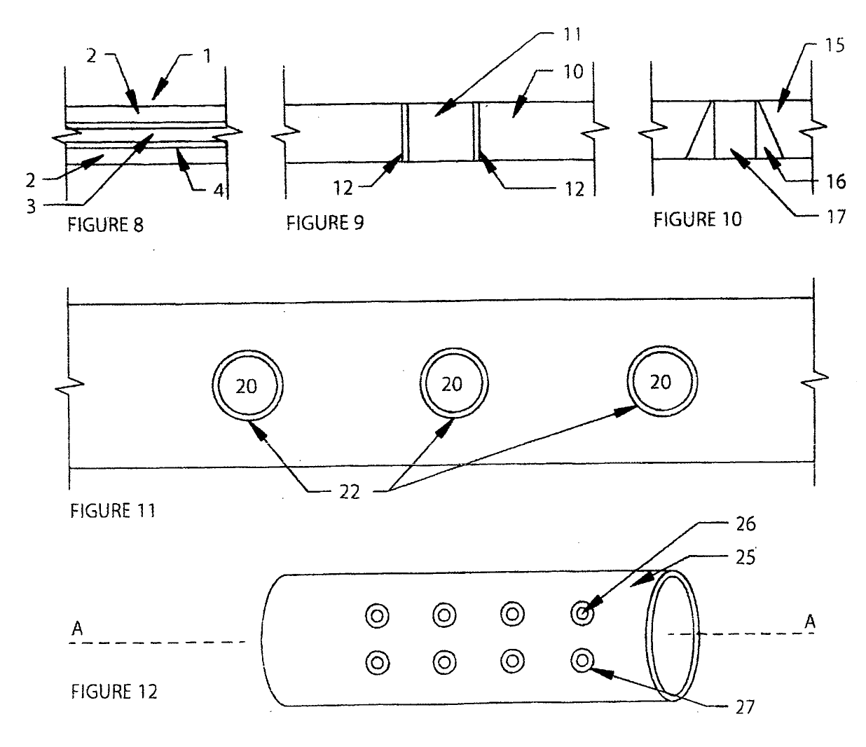

Turning to FIG. 8, the first embodiment of the invention includes a coaxial cable 1 comprising an outer support structure made of mild steel, a central first region in the form of a ferromagnetic core 3 insulated from the support structure 2 by a second region in the form of a cylindrical sheath 4 made of a good thermal or electrical conducting metal such as copper or brass. Preferably, the cable 1 is externally electrically insulated by, for example, polymeric material.

Referring to FIG. 9, the second embodiment is shown comprising a support structure in the form of a planar stainless steel plate 10 in which is embedded a first region in the form of a ferromagnetic plug 11. The support structure 10 and the plug 11 are insulated magnetically from each other by a second region in the form of a cylindrical sleeve 12. Similarly, in FIG. 10, the third embodiment includes a support structure 15 having a truncated conical bore in which is inserted a correspondingly shaped second region in the form of a copper frusto conical sleeve 16 having a central cylindrical bore adapted to receive a first region in the form of a ferromagnetic plug 17.

In FIG. 11, the fourth embodiment includes a regular array of permanent magnets 20 embedded in a strip or plate forming a support structure 21. The permanent magnets 20 are insulated from the support structure 21 by cup shaped second region insulators 22 relatively impermeable to magnetic flux emanating from the permanent magnets 20, having good thermal and electrical conductivity and been made from copper or brass.

According to the invention, when heat or a potential difference is applied to support structure 1, 10, 15, 21, and good conducting second region 4, 12, 16, 22, the second region conducts rapidly according to its properties whilst the support structure and the first region 3, 11, 17, 20, conduct poorly. The high conductivity of the second region serves to prime the conductivity of the support structure by preheating or enhancing the potential difference of the support structure at the surface interface between the second region and the support structure. The poor conductivity of the first region serves to concentrate the inductance of the support structure at the aforementioned surface interface resulting in a surprisingly high rate of conductivity of the support structure.

In FIG. 12, the fifth embodiment is shown having a support structure in the form of a cylindrical drum 25 inlaid with permanent magnet plugs 26 arranged in a regular array over the cylindrical outer surface of the drum 25. Each magnet 26 is magnetically insulated from the support structure 25 by cups 27 made of copper or brass. The drum 25 is adapted to rotate about axis A. The drum 25 may be used in a hot foil pressing process.

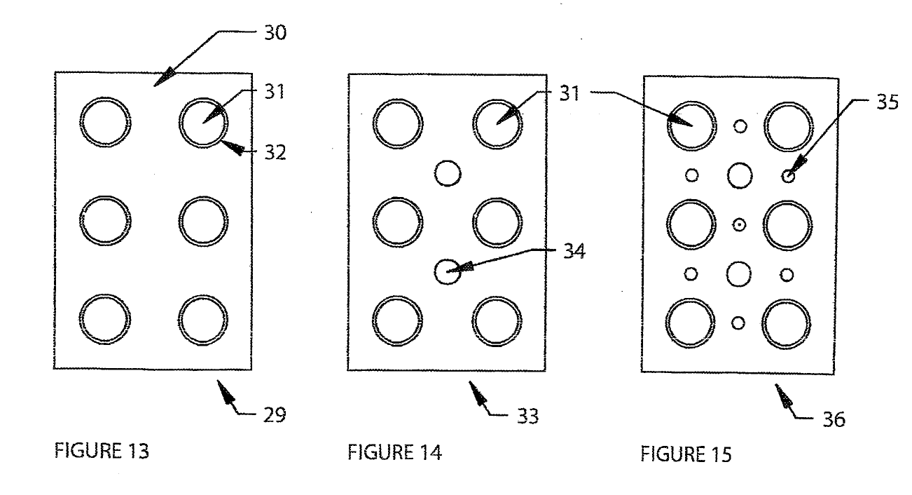

In FIG. 13 a magnetic plate 29 is shown comprising a support structure in the form of a planar steel plate 30, a plurality of regularly spaced first regions in the form of cylindrical magnets 31, each magnet 31 surrounded by a second region in the form of a hollow cylindrical sleeve 32. The magnets 31 are preferably made of samarium cobalt. The sleeves 32 are preferably made of copper.

The magnetic plate 29 is shown in schematic form. It may be A4 sized and include a grid-like array of magnets 31 being 5 mm in diameter and spaced 8 mm from each adjacent magnet 31. The magnetic plate 29 may therefore have around 330 equispaced magnets 31 embedded in corresponding cylindrical bores therein. The magnets 31 may be variously sized as 3.5 or 8 mm in diameter. The copper sleeves 32 may be 1, 2 or 3 mm in wall thickness. The copper sleeve 32 assists to enhance the conductivity of the magnetic plate 29 whereby it displays a superior rate of conductivity compared to a similarly dimensional copper plate.

Enhanced rate of conductivity of a metal plate may be obtained by an arrangement shown in principle in FIG. 14 concerning a magnetic plate 33. In addition to the magnets 31 and sleeves 32, intermediate each set of four adjacent magnets 31 is a copper plug 34 which does little to compromise the strength of the magnetic plate 33, but enhances the rate of conductivity of same. Similarly, in FIG. 15, the addition of smaller copper plugs 35 between each pair of adjacent magnets 31 further enhances the rate of conductivity of the magnetic plate 36.

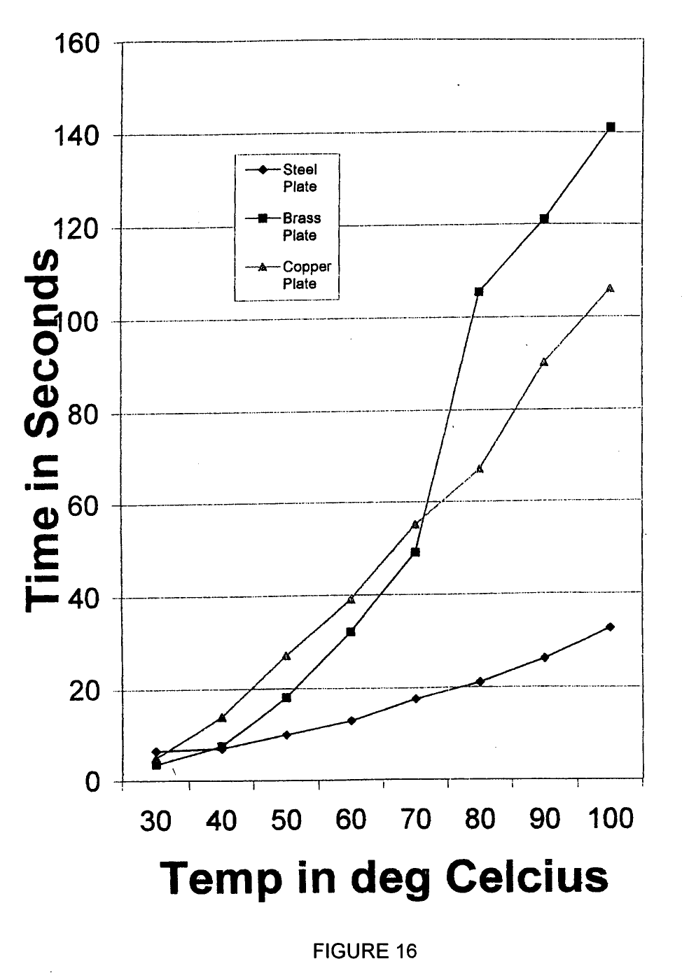

Turning now to the graphs, in FIG. 16 there are shown the comparative results of a test for the heat transfer rate of a steel plate, a brass plate and a copper plate. Clearly, the brass plate demonstrates poor heat conductivity, closely followed by the copper plate. Unexpectedly, the plain steel plate demonstrates superior heat conductivity. As persons skilled in the art will appreciate, it can be inferred from these results that the steel plate would also demonstrate inferior electrical conductivity also.

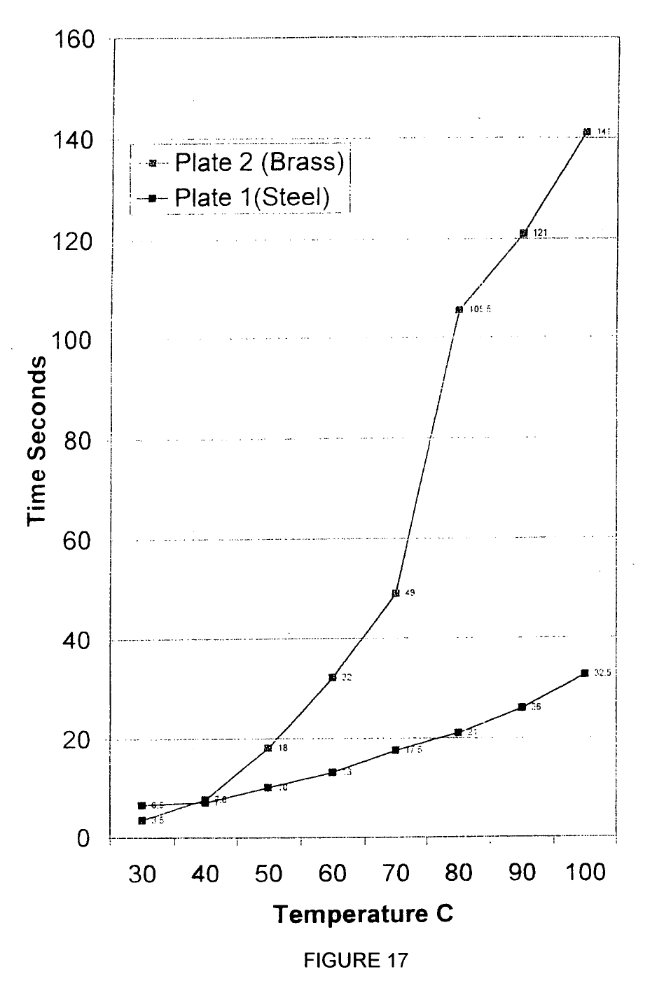

In FIG. 17 there is shown the comparative results of a second heat transfer rate test again demonstrating the steel plate to be vastly superior to the brass plate in terms of thermal conductivity. Again, it can be inferred from these results that the steel plate would also demonstrate excellent electrical conductivity.

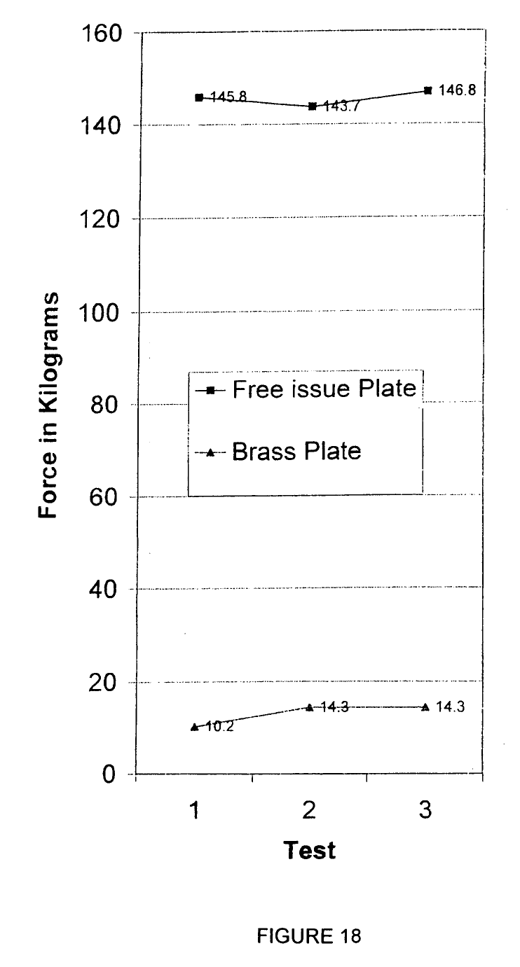

In FIG. 18 there is shown a comparison between the free issue plate of the invention, particularly as described with reference to FIG. 1 above in which the magnetic holding power of the free issue plate is demonstrated to be vastly superior to that of a corresponding brass plate such as that described in U.S. Pat. No. 5,904,096 (Fawcett et al).

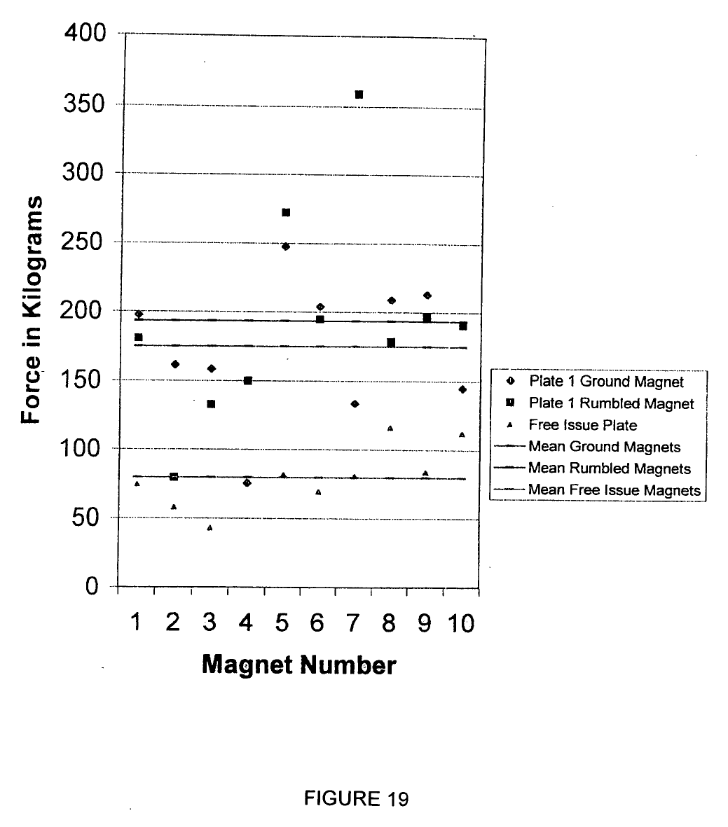

In FIG. 19 there is shown the results of comparative tests of the free issue plate, a ground magnet plate and a rumbled magnet plate in which the rumbled and ground magnet plates generally show superior retention of magnetic properties at ambient temperature compared to the free issue magnetic plate.

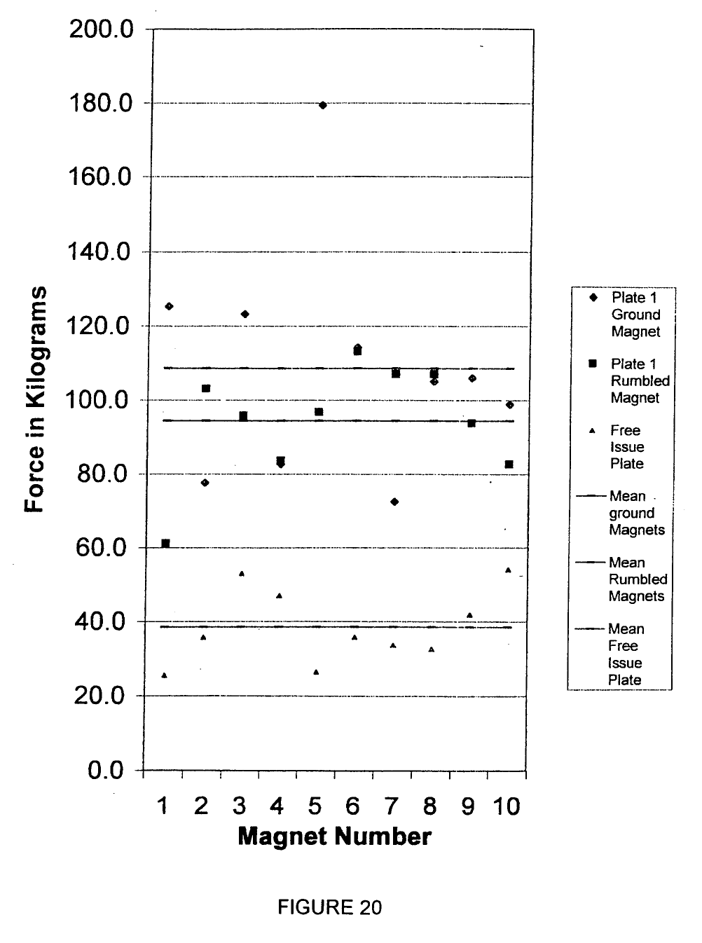

In FIG. 20 the same test in FIG. 12 was repeated but at a temperature of 160° C. in which the ground magnet demonstrates a slightly greater holding strength than the rumbled magnet and that both of these show considerably superior magnetic holding properties compared to the free issue plate.

Throughout the specification the word “comprise” and its derivatives are intended to have an inclusive rather than exclusive meaning unless the context requires otherwise.

### Industrial Applicability

The invention has industrial applicability at least in relation to the graphic arts industry, and more particularly, in relation to the releasable attachment of steel-backed dies to such machines.

It will be apparent to those skilled in the art that many modifications and variations may be made to the embodiments described herein without departing from the spirit or scope of the invention.

1. A magnetic holding device including:
a) a support structure made of an iron alloy and having a substantially planar bearing surface;
b) at least one magnetic or magnetisable region located in said support member; and
c) insulating means made of non-magnetic material interposed between said region and said support structure to resist magnetic induction of, or leakage to, said support structure.

2. A magnetic holding device according to claim 1, wherein the devices is in the form of a plate, having two opposed planar surfaces.

3. A magnetic holding device according to either claim 1 claim 2, wherein the device is rectangular.

4. A magnetic holding device according to any one of the previous claims, wherein the device is used as a spacer plate in graphic art design processes and the magnetic holding device is between about 4 mm and 6.5 mm thick.

5. A magnetic holding device according to any one of the previous claims, wherein the bearing surface of the spacer plate includes sizes of about 210×150 mm (A5 size), 300×210 mm (A4 size) or 420×300 mm (A3 size).

6. A magnetic holding device according to any one of the previous claims, wherein the support structure includes one or more bores adapted to receive the one or more magnetic or magnetisable regions.

7. A magnetic holding device according to any one of the previous claims, wherein the support structure is made of steel, including mild steel, case-hardened steel, stainless steel and the like.

8. A magnetic holding device according to any one of the previous claims, wherein the at least one magnetic or magnetisable region includes a magnetisable core subject to an electric field to induce magnetism or is in the form of a permanent magnet.

9. A magnetic holding device according to any one of the previous claims, wherein the magnetic holding device includes a plurality of magnetic or magnetisable regions in spaced relationship with one another.

10. A magnetic holding device according to any one of the previous claims, wherein the one or more magnetic or magnetisable regions have a diameter of 2-10 mm.

11. A magnetic holding device according to claim 10, wherein the at least one magnetic region has a diameter of 3-6 mm.

12. A magnetic holding device according to any one of the previous claims, wherein the at least one magnetic region has a substantially cylindrical shape.

13. A magnetic holding device according to claim 12, wherein the at least one magnetic region has an axial length less than the thickness of the support structure.

14. A magnetic holding device according to any one of the previous claims, wherein the, the bore in which the magnetic region resides is in the shape of a cup, channel or block.

15. A magnetic holding device according to any one of claims 1 to 13, wherein the bore in which the magnetic region resides is cylindrical.

16. A magnetic holding device according to any one of the previous claims, wherein the device the distance separating the adjacent magnetic regions falls within the range of 5-25 mm.

17 A magnetic holding device according to claim 16, wherein the distance is 6-8 mm.

18. A magnetic holding device according to any one of the previous claims, wherein the plurality of magnetic regions is orientated so that the north poles are co-planar.

19. A magnetic holding device according to any one of claims 1 to 17, wherein the magnetic regions are grouped so that members within each group share the same pole in a common plane but have opposite poles to each adjacent group.

20. A magnetic holding device according to any one of the previous claims, wherein adjacent magnetic regions have opposite poles whereby to maximise the magnetic field intensity of any particular point on the bearing surface of the magnetic holding device.

21. A magnetic holding device according to any one of the previous claims, wherein the insulating means is made from a wide range of non-magnetic materials effective to insulate the support structure against direct magnetic leakage.

22. A magnetic holding device according to any one of the previous clams, wherein the magnetic regions include a magnetic surface which lies close to or flush with the planar bearing surface.

23. A magnetic holding device according to any one of claims 1 to 21, wherein the magnetic surface lies flush with the planar bearing surface to maximise the magnetic force applied to a work piece, such as a steel backed die.

24. A magnetic holding device according to any one of claims 1 to 21, wherein the magnetic surface lies just beneath the plane of the planar bearing surface to reduce the incidence of fatigue in the magnetic regions which may be sustained during a graphic art design process.

25. A magnetic holding device according to any one of the previous claims, wherein the insulating means is made of any suitable non-magnetic material, for example, non-magnetic metals such as copper, brass, zinc or aluminium, copper alloys, aluminium alloys, magnesium alloys, nickel, titanium, or from other materials including polymeric materials including tempered glass fibre, metal fibre, carbon fibre or graphite fibre.

26. A magnetic holding device according to any one of the previous claims, wherein the polymeric material includes a thermoset resin selected from the group including allyl polymers, epoxy polymers, furan, melamine formaldehyde, melamine phenolic polymers, phenolic polymers, polybutyldiene polymers, thermoset polyester and alkyd polymers, thermoset polyamide polymers, thermoset polyurethane polymers, flexible thermoset silicone polymers, silicone epoxy polymers and thermoset ureapolymers.

27. A magnetic holding device according to any one of claims 1 to 25, wherein the insulating means is copper alloy.

28. A magnetic holding device according to any one of the previous claims, wherein the insulating means is in the form of a tube where the magnetic region extends from one face of the support structure through to its opposite face or in the form of a cup where the bore in which the region resides does not extend entirely through the support structure.

29. A magnetic holding device according to any one of the previous claims, wherein the magnetic holding device is nickel plated, to provide resistance against rusting and scratching, due to the superior characteristics of nickel.

30. A magnetic holding device according to any one of the previous claims, wherein to enhance and improve heat conductivity, additional solid copper or brass rods are utilised in addition to insulated magnetic regions.

31. A magnetic holding device according to any one of the previous claims, wherein the magnetic device for a hot foil stamping press employing a cylinder, is provide with engagement means to assist retention in the press.

32. A method of manufacturing a magnetic holding device including at least one magnetic body located in a support structure, said method including the steps of:
a) forming at least one bore in said support structure, said support member being made from a hard iron alloy and having a substantially planar bearing surface;
b) inserting insulating means made from non-magnetic material into said bore, said insulating means defining a hole substantially coaxial with said bore; and
c) inserting the magnetic body into said hole,
wherein said insulating means is interposed between said magnetic body and said support structure to resist magnetic induction of, or leakage to, said support structure.

33. A method of manufacturing a magnetic holding device including at least one magnetic body located in a support structure, said method including the steps of:
a) forming at least one bore in said support structure, said support structure being made from an iron alloy and having a substantially planar bearing surface;
b) inserting said body into insulating means to form an insulated body having an internal magnetic core surrounded by non-magnetic insulating means; and
c) inserting said insulated body into said bore, wherein said insulating means is interposed between said internal core and said support structure to resist magnetic induction of, or leakage to, said support structure.

34. A method of manufacturing a magnetic holding device according to either claim 32 or claim 33, wherein the bore may be formed in the support structure by any one of a range of means familiar to the person skilled in the art.

35 A method of manufacturing a magnetic holding device according to claim 34, wherein the bore is formed by machining the support structure and the bore may extends entirely through the support structure or may extend part way through to form a recess.

36. A method of manufacturing a magnetic holding device according to claim 35, wherein the bore is any suitable shape or configuration such as block, square, rectangular or triangular shaped.

37. A method of manufacturing a magnetic holding device according to claim 34 wherein, the magnetic body is preferably cylindrical or disc-shaped, and the bore is correspondingly cylindrical or cup shaped.

38. A method of manufacturing a magnetic holding device according to claim 32 or claim 33, wherein the magnetic body is inserted into the insulating means using correspondingly threaded or otherwise grooved means to mutually engage.

39. A method of manufacturing a magnetic holding device according to claim 38 wherein, the magnetic body is press fitted into the insulating means.

40. A method of manufacturing a magnetic holding device according to claim 38 wherein, the magnetic body is bonded into the insulating means by utilising an adhesive or other chemical compound.

41. A method of manufacturing a magnetic holding device according to either claim 32 or claim 33, wherein the insulated body is press fitted into the bore, relying on the malleability of the insulating means to ensure a tight fit.

42. A method of manufacturing a magnetic holding device according to claim 41 wherein, the retention of the insulated body in the bore is improved by utilising adhesive or other chemical means.

43. A method of manufacturing a magnetic holding device according to claim 32 or claim 33, wherein the wall thickness of the insulating means is between 10 μm and 3 mm.

44. A method of manufacturing a magnetic holding device according to either claim 32 or claim 33, wherein the outer wall of the insulating material is provided with a step or steps to help prevent the insulated magnetic core from being prematurely ejected from the magnetic plate under pressure from constant use.

45. A method of manufacturing a magnetic holding device according to either claim 33 or claim 34 wherein, the bearing surface of the magnetic holding device is substantially smooth and planar.

46. A method of manufacturing a magnetic holding device according claim 45 wherein, the planar bearing surface is ground using a grinding machine to render the bearing surface substantially planar.

47. A method of manufacturing a magnetic holding device according claim 46 wherein, the underside of the magnetic holding device is also ground to ensure a uniformly flat surface thereunder as well.

48. A metal conductor including:
a support structure made of an iron alloy;
a first region made of a relatively poor thermal and electrical conducting metal located in said support structure; and
a second region made of a relatively good thermal and electrical conducting metal surrounding the first region from the support structure, whereby the rate of thermal and electrical conductivity of the metal conductor as a whole is better than the rate of the thermal or electrical conductivity of the second region material alone.

49. A metal conductor according to claim 48 wherein the support structure is cylindrical, corrugated, regular, spherical, block-shaped or planar.

50. A metal conductor according to claim 49, in the case of a hot foil stamping process, where the support structure is predominantly planar or cylindrically shaped.

51. A metal conductor according to any one of claims 48 to 50, in which the support structure is made of steel, including mild steel, case-hardened steel, stainless steel, or carbon-steel.

52. A metal conductor according to any one of claims 48 to 51 wherein the second region is made from a variety of good thermal and/or electrical conducting materials, including copper, nickel, silver, gold, aluminium, zinc, magnesium, titanium, or a combination of two or more of the aforementioned, which is be used to form alloys such as copper alloys including brass, aluminium alloys and magnesium alloys.

53. A metal conductor including:
a support structure made of an iron alloy;
a first magnetic or magnetisable region located in the support structure;
a second region made of a relatively good thermal and electrical conducting metal surrounding the first region,
whereby the rate of thermal and electrical conductivity of the metal conductor as a whole is better than the rate of thermal or electrical conductivity of the second region material alone.

54. A metal conductor according to claim 53 in which the poor conducting metal of the first region includes metal alloys comprising a large proportion of iron and other elemental components similarly possessing poor heat and/or electrical conducting properties, including samarium cobalt (SmCo¹⁷) having a magnetic flux of 16-32 MGOe (Mega Gauss Orsted) and neodymium-iron-boron (NdFeB) with an MGOe of 24-48.

55. A metal conductor according to claim 53 or claim 54, in which the first region comprises a plurality of separate regions forming islands each surrounded by a second region and set in the support structure.

56. A metal conductor according to claim 55, wherein the first regions are irregularly or randomly scattered throughout the surface of the support structure.

57. A metal conductor according to claim 55, in which the first region comprises a regular array of islands.

58. A metal conductor according to any one of claims 49 to 57, in which the first region is made from ferromagnetic material and is in the form of a plurality of discreet solid cylinders or plugs arranged in a regular array flush with the surface of the support structure.

59. A metal conductor according to claim 58, wherin the plugs extend from one external surface of the support structure to an opposed external surface.

60. A magnetic holding device including:
a) a support structure made of an iron alloy including one or more recesses and having a bearing surface;
b) at least one magnetic or magnetisable region located in said recess of said support structure; and
c) insulating means made of non-magnetic material interposed between said region and said support structure to resist magnetic induction of, or leakage to, said support structure from said region.

61. A magnetic holder device according to claim 60, in which the bearing surface is in the form of a planar, cylindrical or otherwise curved surface.

62. A metal conductor including:
a support structure made of an iron alloy;
first poor conducting regions made of metal located in said support structure;
second good conducting regions, each second good conducting region made of metal which surrounds one of the first regions from the support structure; and
a third good conducting region intermediate at least two of the second good conducting regions,
whereby the rate of thermal and electrical conductivity of the metal conductor as a whole is better than the rate of the thermal and electrical conductivity of the material of the second or third good conducting regions alone.

63. A metal conductor according to claim 62, in which the third good conducting region is preferably isolated from the second good conducting regions.

64. A metal conductor according to claim 63, wherein the third region is preferably embedded in the support structure.

65. A metal conductor according to any one of claims 61 to 64 in which the third region is fixedly seated or inserted in a bore in the support structure.

66. A metal conductor according to claim 65, in which the first, second and third regions are arranged in a regular array, including equidistant relative to adjacent second regions.

66. A metal conductor according to any one of claims 61 to 66 in which the third region includes a plurality of islands intermediate the second regions.

67. A metal conductor according to claim 66, in which the islands are rod-like, plate-like, cylindrical, conical, truncated conical, square or rectangular box-like, or cylindrical.

68. A metal conductor according to claim 66 or claim 67, in which the islands are made from any non-ferrous metal or metal alloy such as copper or brass or any material of which the second region may be made.

69. A metal conductor according to any one of claims 61 to 68 wherein it is formed from sub-units.
Two or more individual metal conductors may be combined to present a larger unitary top bearing surface, the sum of the individual sub-units. Where the metal conductors are plates, the plates may be abutted side by side to present a substantially seamless top bearing surface. At least one peripheral edge of each sub-unit may include alignment means to ensure the correct alignment of the sub-units and, optionally, the engagement of one sub-unit to an adjacent sub-unit. The alignment means may include male or female components, such as a male components on a first sub-unit and a female component on a second sub-unit. The alignment means may include tongue and groove, a pin and hole, rail and slot arrangements or any other suitable protrusion and recess combination. The sub-units preferably exhibit little lateral magnetic attraction or repulsion to enable easy coaction of one sub-unit with another.

70. A method for aligning a die having a top peripheral surface adjacent a relief surface to a magnetic holding device as described herein having a bearing surface in a graphic art design process including:
a) aligning said magnetic holding device on a ferrous metal support;
b) aligning said die on said magnetic holding device; and
c) securing said die to said magnetic holding device by applying to said top peripheral surface and to said bearing surface a length of single sided adhesive tape,
wherein the adhesive is sufficiently strong to ensure that said die remains in position during said graphic art design process.

71. The die may include a range of configurations and materials which are in common use in the industry. The die may include brass, copper, magnesium, aluminium, zinc, or polymeric (or composites thereof), optionally 0.5 mm to 2 mm or 1/32 to 1/16 inch thick with the relief surface standing proud above the line of the remaining top surface of the die. Such dimensions are suitable for use in the present inventive method.

72. The top peripheral surface may extend only along one edge of the die. Preferably, however the top peripheral surface extends around the entire top surface of the die. The top peripheral surface may be recessed to permit the application of tape on its surface without rising above the line of the surface on which the relief is located (“the relief surface ”). The top peripheral surface may be between 5 mm and 50 mm wide, preferably being about 10 mm to 20 mm wide. The depth of the recess would depend on the thickness of the tape being used, but as a general guide may be between 0.1 mm and 2 mm deep.

73. The relief surface is preferably central to the top surface of the die and is of a dimension and nature well known in the art and dependant on the nature of the graphic art to be produced.

74. The magnetic holding plate may be in accordance with the magnetic holding device described above. The magnetic holding plate provides an easily manipulable support for bearing the die, particularly when handling the die during a graphic art design process involving high temperatures. Accordingly, advantageously the magnetic holding plate has sufficient magnetic flux to stably adhere to the chase without being displaced during a production run, but is sufficiently movable by standard manual tools to achieve desired alignment of the die preparatory to a production run. To this purpose, it may be desirable in some applications to have a magnetic holding plate of smaller plan proportions whereby to minimise the magnetic force applied by the magnetic holding plate to the chase as a whole.

75. Accordingly, in some applications it may be preferable to utilise a combination of two or more magnetic holding plates of smaller dimensions which are separately easily manoeuvrable, but which may be combined to form a larger unitary bearing surface on which the die may be mounted. Accordingly, the magnetic holding plate may be formed from a plurality of sub-units.

76. The sub-units may include alignment means. The alignment means may be located along one or more peripheral edges of the sub-unit. Adjacent sub-units may include complementary alignment means. The alignment means may effectively provide engagement means which may be releasable when it is required to separately manipulate and re-align or remove one or more of the sub-units from the chase. The alignment means may include male and female components. The alignment means may include tongue and groove, protrusion and hole, flange and slot, rail and recess arrangement and the like.

77. The peripheral edges of the sub-units may be cut to low tolerance by a high precision cutting implement, such as a wire cutter or a laser cutter, so that on abutment with an adjacent sub-unit, the top bearing surface presented to the die is virtually seamless.

78. The tape may be high temperature resistant and suitable for use in a hot foil stamping process or any other graphic art design process involving elevated temperatures. The adhesive used is preferably of a type that will not cure at the operating temperatures during the process and is easily removed without leaving residue. The backing of the tape may be a polymeric film such as polyamide or polyester, glass cloth tape, crepe paper masking tape, such as smooth or mini or thicker crepe paper.

79. Polyamide backing may be used in applications requiring performance stability at high temperatures. Glass cloth backing may be useful where dies are subject to some shearing forces, such as may be experienced where the stamping process involves a cylindrical drum rather than a linearly reciprocating stamping means because of the relative high tensile strength of glass cloth backing. It may also be useful at extremely high temperatures. Polyester film backing will be useful in applications involving very long production runs due to its abrasion, chemical and thermal resistance under wide-ranging conditions.

80. The adhesive may include silicone adhesive for high temperature resistance and easy removal without leaving residue on the die or magnetic holding device.

81. Preferably the method for aligning the die includes the further steps of:
e) carrying out the graphic art design process; and subsequently
f) peeling the tape off the top peripheral surface and the bearing surface,
such that no adhesive residue remains on the top peripheral surface or the bearing surface and the die is not damaged by peeling of the tape in step f).

82. The die may be in the form of a thin wafer about 0.5 mm to 1.5 mm, and preferably 1.3 mm or 1/16 inch in thickness.

83. The top peripheral surface may be recessed relative to the relief surface to ensure the tape does not interfere with the graphic art design process. Accordingly, the height difference between the recessed top peripheral surface and the supporting surface for the relief (“the relief surface”) is greater than or equal to the thickness of the tape.

84. Where the die has an original thickness greater than that desired for the graphic art design process, such as ¼ inch or 7 mm, the method for adhering the die may further include a preliminary step involving cutting the die to a thickness of substantially 1.3 mm or 1/16 inch.

85. A magnetic holding device substantially as described herein with reference to the drawings.

86. A method for manufacturing a magnetic holding device substantially as described herein in conjunction with the drawings.
